(19) United States
(12) Patent Application Publication
(10) Pub. No.: US 2022/0072792 A1
(43) Pub. Date: Mar. 10, 2022

(54) 3D PRINTING METHOD EMPLOYING ADAPTIVE INTERNAL SUPPORT STRUCTURE

(71) Applicant: Beijing University of Technology, Chaoyang District, Beijing (CN)

(72) Inventors: Lifang WU, Chaoyang District, Beijing (CN); Lidong ZHAO, Chaoyang District, Beijing (CN); Yuxin MAO, Chaoyang District, Beijing (CN); Tianqin YANG, Chaoyang District, Beijing (CN); Meng JIAN, Chaoyang District, Beijing (CN); Ye XIANG, Chaoyang District, Beijing (CN); Ge SHI, Chaoyang District, Beijing (CN)

(73) Assignee: Beijing University of Technology, Chaoyang District, Beijing (CN)

(21) Appl. No.: 17/419,429

(22) PCT Filed: Dec. 29, 2018
(86) PCT No.: PCT/CN2018/125213

§ 371 Date: Jun. 29, 2021

(51) Int. Cl. B29C 64/386

(52) U.S. Cl. CPC B29C 64/386; B33Y 50/00

(57) ABSTRACT

A 3D printing method employing an adaptive internal supporting structure, involving the steps of: S1—extracting images from a reference biological structure picture to obtain a multi-layer grid texture serving as a plurality of layer pictures for an internal supporting structure of a 3D model; S2—separating multi-layer structures of the model layer-by-layer, and performing binarization and hollowing processing on each layer to obtain a plurality of images; S3—merging each layer picture obtained in step S1 with a corresponding image obtained in step S2 to obtain a plurality of final slice layer structures; S4—determining a support region of the supporting structure in each slice layer according to strength requirements; S5—analyzing the model to perform adaptive structural design and adjusting its strength-material ratio; and S6—restoring the model by using a 3D reconstruction algorithm and printing the model.

### FIELD OF THE DISCLOSURE

The disclosure relates to the generation of an internal supporting structure for 3D printing of a model. According to the structural difference of different parts of the model, two different internal supporting structures that can be applied to different structures are added. Printing materials can be saved, while a certain strength level of the model can be ensured.

### BACKGROUND

3D printing is a kind of rapid forming technology, which, based on digital model files, constructs an object by using powdered metal or plastic and other adhesive materials through a layer by layer printing procedure. The most prominent advantage of this technology is that it can directly generate parts of any shape from computer graphics data without machining or using any mold, and thereby the product development cycle can be greatly shortened, productivity can be improving, and production cost can be reduced.

Although 3D printing technology has brought about rapid development in science and technology, the same emerging industry will also have a variety of issues including strength, accuracy, material limitations and cost. In particular, materials that can be used are very limited and costly, and there are not many alternatives can be selected. Traditional models are designed as a solid structure. Although it has the highest strength, but due to the total volume limitation, the printer's running trajectory is increased and the material amount is almost doubled. In order to avoid this problem, the easiest way is to hollow out the inside and leave a “shell”. However, this kind of practice will cause a decrease in strength and even lose the original functions of the model. Therefore, on the basis of hollowing out, additional internal supports are added to minimize the amount of the consumed model material while ensuring the necessary strength to achieve a balanced effect.

In addition, models are generally complicated, mechanical structures of different parts are not the same, and it cannot be treated with a single type of internal supporting structure. This will increase the overall material consumption due to the strength requirements of fragile parts, thereby increasing the waste of materials.

### SUMMARY

A main object of the disclosure is to generate a 3D printing supporting structure for a biological structure in a 2D to 3D manner. This method reduces the problem of large consumption of traditional solid structural materials, and at the same time increases the strength under force in a specified direction of the model through an adaptive algorithm, which has good practical significance and theoretical research value for ensuring structural strength and saving printing materials.

Based on research on biological body structures, the disclosure builds a mechanical device similar to the biological body or a part of it, so that the model structure design is more reasonable. Similar functions can be realized by structural similarity, and its strength, toughness and practicability can also be simulated and verified by testing the formed items. Combining 3D printing model design with bionic technology can achieve highly optimized and coordinated results, thereby improving the adaptability of the designed model to the environment.

Crystal structure, such as diamond, belongs to the simple substance of carbon. It is a molecular structure with excellent physical properties such as super-hardness, wear resistance, heat sensitivity, thermal conductivity, semiconductor and penetration. The Mohs hardness of diamond is 10. Since it has the highest hardness among natural substances, it is used as the internal supporting structure material of the model in the disclosure.

Therefore, the disclosure proposes a design algorithm for the internal supporting structure of the three-dimensional model, which is a logic based on the biological structure, and is developed from the perspective of printable layers.

The technical solution of the disclosure is realized by the following steps:

1) extracting a picture of a reference biological structure for forming a supporting structure to obtain a complete texture structure image;

2) performing fusion processing to the obtained texture image and a model slice that needs to add an internal supporting structure to obtain a complete slice image with the internal supporting structure;

3) performing model analysis and adaptive structural design, in which a strength-to-material ratio is adjusted;

4) restoring a three-dimensional model through a three-dimensional reconstruction algorithm; and

5) performing a simulation test to the model to verify the effectiveness of the algorithm.

The disclosure will be described in detail below in conjunction with the drawings and implementation steps.

### BRIEF DESCRIPTION OF DRAWINGS

FIG. 1 is a block view of a skeletal muscle-based supporting structure design scheme of the disclosure;

FIG. 2 shows a cross-sectional view of skeletal muscle and a sectional view of a basic structural unit;

FIG. 3 shows results of two algorithms;

FIG. 4 is a composite image of skeletal muscle having a larger area;

FIG. 5 shows an example of the fusion of a model slice structure and biological structure;

FIG. 6 show perspective views of a fixing socket;

FIG. 7 shows an example of a model for layered processing;

FIG. 8 shows images of some model slices;

FIG. 9 shows a curve of the change in area ratio;

FIG. 10 shows schematic views showing the processing of a key slice;

FIG. 11 shows cross-sectional views of the model; and

FIG. 12 shows the model under force analysis.

### DETAILED DESCRIPTION

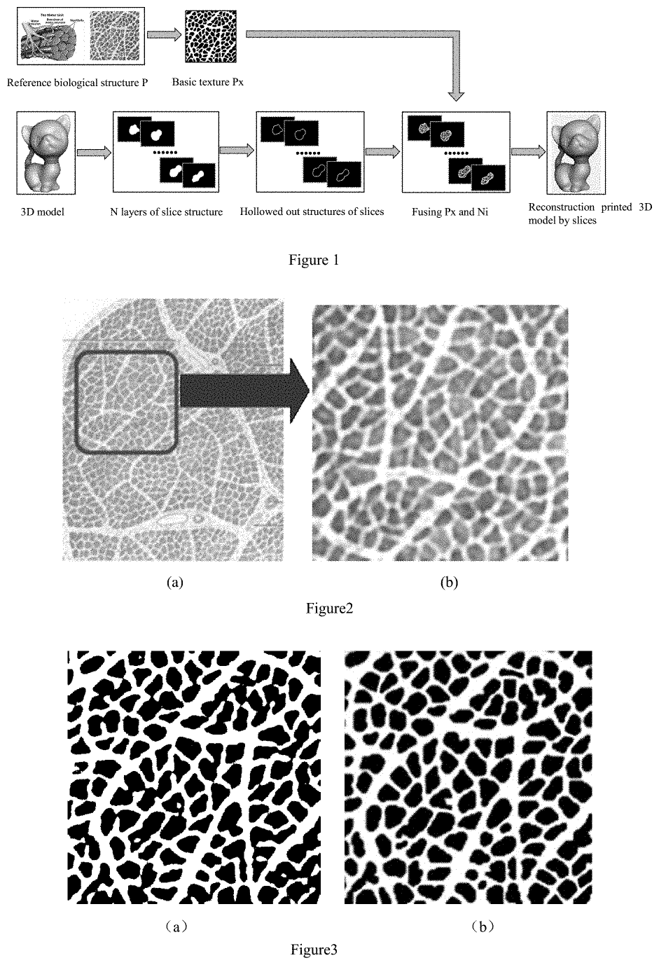

The disclosure is based on 2D slice image processing. A system of the disclosure includes a computer and an FDM type 3D printer, and can generate internal supporting structure for any given model. As shown in FIG. 1, as a first step, a picture P of a reference biological structure to be used in forming a supporting structure (here, a skeletal muscle structure) is extracted, and the picture of the basic texture of the structure is extracted to obtain a grid texture Pₓ, which is used as a layered picture of an internal supporting structure of the model. Then the three-dimensional model is divided layer by layer into an N-layered structure, and each layer is used as a picture to be binarized and hollowed out to obtain picture Nᵢ (i=1, 2, 3, 4 . . . ). Then a final sliced layer structure can be obtained by synthesizing Pₓ and Nᵢ. Then it judges whether the fusion of all slices is completed. Since each layer of the model may not have the optimal strength-to-material ratio, it is necessary to adaptively design the skeletal muscle supporting structure according to the strength requirements of the model, that is, the area of a supporting region of each slice according to the supporting strength is estimated, and the minimum area of the supporting region that meets the requirements is obtained by comprehensively consideration. By using this slice as a reference, the slice structures of other layers are then adaptively determined. Finally, the 3D model is restored through the 3D reconstruction algorithm, and then printing is performed.

A specific embodiment of the disclosure will be described below.

(1) FIG. 2 (a) is a cross-sectional view of skeletal muscle. It can be seen from the figure that muscle fibers are basic units of the skeletal muscle. Multiple muscle fibers form a fiber bundle. The composition configurations of the fiber bundles may be arbitrary. The thickness of the connective tissue membrane between the fiber bundles is small, and the uniformity of the skeletal muscle distribution structure is maintained. The connective tissue membrane that wraps multiple fiber bundles is thicker, destroying the uniformity of the skeletal muscle structure. Therefore, the slice structure should avoid the thick connective tissue membrane, with muscle fibers and fiber bundles as the main structure. Then a basic biological structural unit is obtained by cutting, and subsequent processing work is carried out to the basic biological structural unit.

Preprocessing of this biological structure includes biological structure image expansion algorithm and image segmentation algorithm. For the segmentation method, watershed algorithm has a good response to weak boundaries, which is a guarantee for obtaining closed continuous boundaries. The result of the transformation of this algorithm is a water collection basin image of an input image, and the boundary point between the water collection basins is a watershed. Obviously, the watershed represents the maximum point of the input image.

The main purpose of image segmentation is to accurately segment muscle fibers areas (dark colored) and connective tissue areas (white), and the white areas correspond to supporting areas. FIG. 2(b) shows a basic structural unit obtained by cutting, in which the muscle fiber areas have a small gray scale, and the connective tissue areas are theoretically white areas. Due to various factors, these areas are actually gray and white interlaced areas, so the result of a simple binarization method is not very satisfactory. FIG. 3(a) is the result image after the binarization of FIG. 2(b). It can be seen that the connective tissue areas are not completely separated from the muscle fiber areas, and some parts are truncated, which makes the supporting areas disconnected.

FIG. 3(b) is the result image after the processing of FIG. 2(b), that is, the result image of the watershed segmentation. It can be seen that continuous connective tissue areas (supporting areas) are obtained by the watershed segmentation, and the resulting image meets application requirements. For models with larger sizes or larger strength requirements, the skeletal muscle texture structure generated in the previous section will appear relatively sparse and may not meet given strength requirements. In order to ensure that the texture structure has the same force on all four sides, FIG. 2(b) is mirror-symmetrically duplicated, and the final effect diagram is obtained, as shown in FIG. 4.

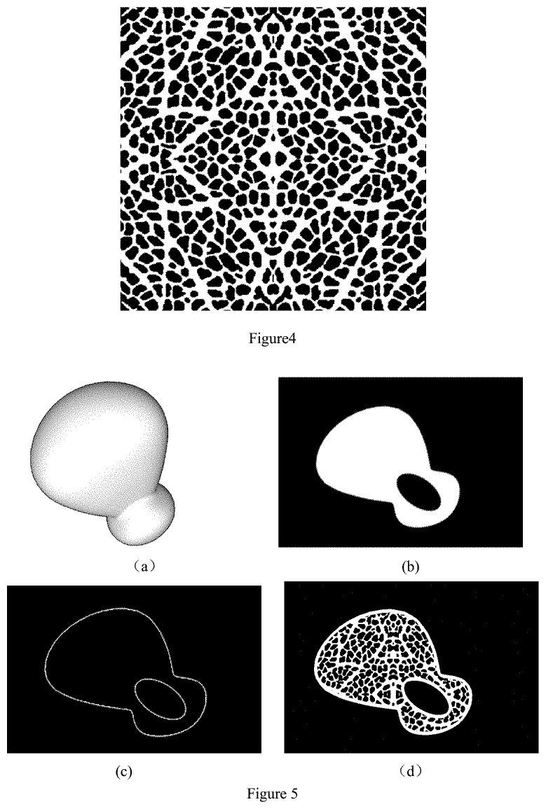

(2) After the texture image of the supporting structure is obtained, an internal supporting structure can be added to the target model. As shown in FIG. 5, in which FIG. 5(a) shows a “fixing socket” of the model, FIG. 5(b) shows the structure of the 440th layer of the solid slice of the fixing socket model, and FIG. 5(c) shows the slice of a hollowed out structure of the model. The model slice and the basic structure image or the extended image of the basic structure are overlapped (logical AND) to obtain the structure of the layer, as shown in the fusion result image in FIG. 5(d).

(3) The purpose of model analysis is to analyze the pressing force and pressure applied on each slice according to supporting strength requirements, and further estimate the required minimum supporting area according to the pressure requirements, calculate the ratio between the minimum supporting area and the existing area, determine the key slice according to the area ratio, and determine a processing method for changing the key slice structure according to the area ratio of the key slice.

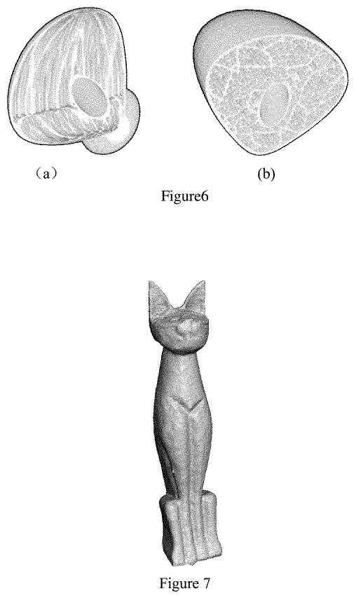

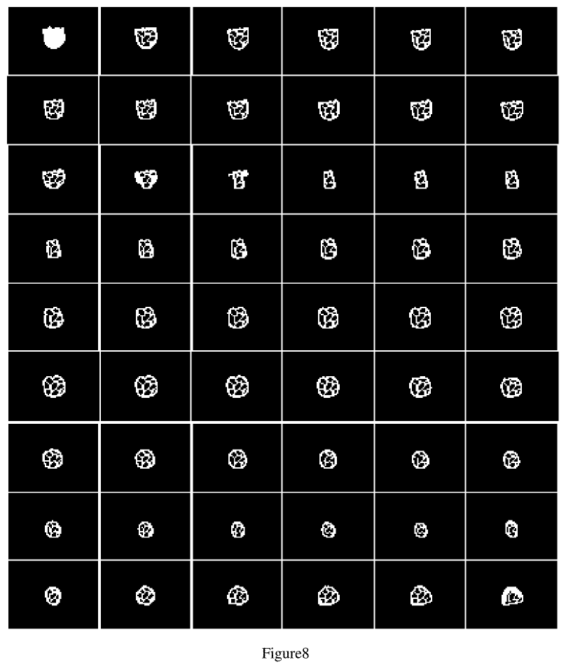

FIG. 7 is a model cat. First, the model is sliced to obtain all slice images, and existing supporting area S₀ of each slice is calculated. FIG. 8 shows slice images separated by 20 layers from each other.

Further, a relationship between the slice area of each layer (S₀), the weight of the single layer (Gₛ) and the specific gravity (d) of the material under a specific pressing force F is calculated. The pure weight of the model is 160 g, a pressing force of F=100 N is applied on the head of the model cat, the thickness of the model slice is H=0.01 mm, the specific gravity of the material is d=0.3575 mg/mm³, and the maximum pressure that the material can bear is P=300 Pa. The pressing force Fₜₒₜₐₗ of each slice can be calculated. Further, the minimum area Sₘᵢₙ required for each layer of slices is calculated, and the weight of a single layer is equal to the area of the layer multiplied by the height and the specific gravity of the material. Since the top of the model is located on the 280th layer, the 0-279th layers are only subjected to the pressing force caused by the model's own weight. The 280th layer has an external force of 100 Newtons. From this layer, the pressing force on each layer suddenly increases. The minimum area required also become bigger.

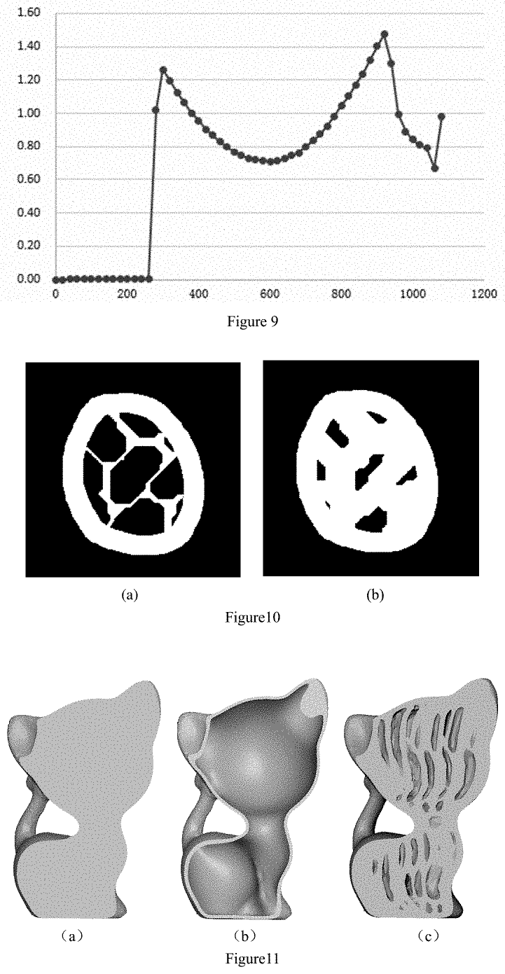

It can be seen from FIG. 9 that the area ratio of the 920th layer is the largest. Therefore, we get the 920th layer as the key layer.

First, the slice corresponding to the largest area ratio is determined as the key slice. If the maximum area ratio is greater than 1, it means that the existing area cannot support the strength required by the existing stress, and the existing supporting area needs to be expanded (dilated). The existing supporting area is expanded by pixel-by-pixel dilation. The existing area is expanded by one pixel width, and the area ratio is recalculated. If the area ratio is still greater than 1, then continue to expand. If the ratio is less than or equal to 1, then stop the expansion, and determine the enlarged area of the supporting area as the width of the expanded pixels.

If the ratio of the maximum supporting area to the existing area is less than 1, it means that the existing area support is redundant in required stress, and the existing supporting area needs to be reduced. The method of pixel-by-pixel eroding is used here. One pixel width is removed by erosion from the existing area, and then the area ratio is recalculated. If the ratio is greater than 1, continue to corrode; otherwise, if the ratio is less than or equal to 1, then stop corroding, and determine the reduced area of the supporting area as the width of the removed pixels.

The key slice is the 920th slice, and the area ratio of this slice is 1.47, indicating that the existing supporting area is insufficient, so the supporting area in the existing slice structure needs to be expanded. Through the pixel-by-pixel expansion, the final expansion pixel width is determined to be 6 pixels.

For the existing supporting areas of other layers, by expanding/removing its width by N pixels according to the operation process described above for the key layer, each layer of supporting structure that meets the stress requirements can be obtained. For the slice image of the illustrated 920th layer, the original slice image and the result image resulted from the expansion of 6 pixels are shown in FIG. 10. FIG. 10(a) is the slice image of the 920th layer, and FIG. 10(b) is the result image after the expansion of 6 pixels.

(4) Using “Marching Cubes”, the sliced three-dimensional structure is reconstructed, so a three-dimensional model with internal supporting structures can be obtained. FIG. 6 shows simulation results, in which FIG. 6(a) is a cross-sectional view of the target model and FIG. 6(b) is a cut-away sectional view of the target model. A clear internal texture can be seen from it.

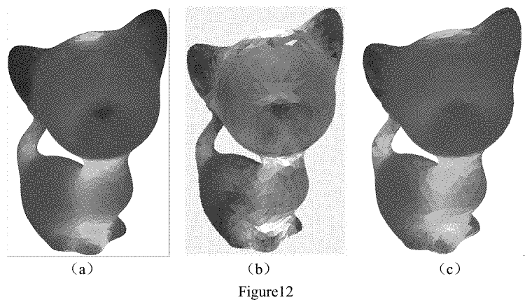

(5) FIGS. 11 and 12 show results of simulation tests. FIGS. 11(a) and 12(a) show solid structures, FIGS. 11(b) and 12(b) show hollow structures, and FIGS. 11(c) and 12(c) show skeletal muscle structures.

From Table 1 below, it can be seen that the model generated by this calculation method can save material by 9.884%, while the strength is almost maintained as the same.

TABLE 1
Comparison of volume and strength

| | Volume of | Volume of | Volume of | | |
|---|---|---|---|---|---|
| | Solid | Hollow | Skeletal | Volume | Pressing |
| | Model | Model | Muscle | Ratio | Force |
| Cat Model | 1131.74 | 111.86 | 1019.88 | 9.884% | 120 |

1. A 3D printing method based on an adaptive internal supporting structure, the method comprising the steps of:
S1: performing image extraction from an image of a reference biological structure to be used for forming the supporting structure to obtain multi-layer grid patterns as multiple layered images of the internal supporting structure of a 3D model;
S2: dividing the 3D model, layer-by-layer, into a multi-layer structure, and performing binarization and hollowing out to each layer to obtain multiple pictures;
S3: fusing each layered image obtained in step S1 with the corresponding picture obtained in step S2 to obtain structures of multiple final sliced layers;
S4: determining a supporting area of the supporting structure in each sliced layer according to strength requirements of the 3D model;
S5: performing analysis and adaptive structural design to the 3D model, and adjusting its strength-to-material ratio; and
S6: restoring the 3D model through a 3D reconstruction algorithm and then printing it.

2. The 3D printing method according to claim 1, wherein for an animal model, the supporting structure is constructed based on connective tissues between muscle fibers.

3. The 3D printing method according to claim 2, wherein in step S1, a continuous connective tissue region obtained by using watershed segmenting algorithm is used as a supporting region.

4. The 3D printing method according to claim 3, wherein in step S1, for each layered image, a block cut out from the layered image is used in determining the supporting region, and the block is symmetrically duplicated to determine a supporting region in an enlarged block.

5. The 3D printing method according to claim 1, wherein in step S4, in the condition that the determined supporting area in each sliced layer is larger than the area of the sliced layer, the area of the sliced layer is expanded in a pixel-by-pixel dilation manner.

6. The 3D printing method according to claim 5, wherein in step S4, in the condition that the determined supporting area in each sliced layer is smaller than the area of the sliced layer, the area of the sliced layer is reduced in a pixel-by-pixel erosion manner.
